(19) United States
(12) Patent Application Publication
(10) Pub. No.: US 2015/0310487 A1
(43) Pub. Date: Oct. 29, 2015

(54) SYSTEMS AND METHODS FOR COMMERCIAL QUERY SUGGESTION

(71) Applicant: Yahoo! Inc., Sunnyvale, CA (US)

(72) Inventors: Jian XU, Beijing (CN); Yu ZOU, Beijing (CN); Chunming WANG, Beijing (CN)

(73) Assignee: Yahoo! Inc., Sunnyvale, CA (US)

(21) Appl. No.: 14/262,120

(22) Filed: Apr. 25, 2014

Related U.S. Application Data
(63) Continuation of application No. PCT/CN2014/076277, filed on Apr. 25, 2014.

(51) Int. Cl. G06Q 30/02; G06F 17/30

(52) U.S. Cl. CPC G06Q 30/0256; G06F 17/30864; G06F 17/3053

(57) ABSTRACT

Systems and methods for commercial query suggestion are disclosed. The system includes a database including search logs. The system includes a set of initial suggestion phrases extracted from the database. The system includes a search engine that generates a query search result based on a query and generates a suggestion search result based on each suggestion phrase in the set of initial suggestion phrases. The system includes a feature generation device that generates a query vector and a suggestion vector based on the query search result and the suggestion search result. The system obtains a relevance score for each suggestion phrases based on a relevance model. The system includes a subset of the initial suggestion phrases based on the relevance scores. The system obtains a click probability score for each suggestion phrases in the subset of initial suggestion phrases based on a click model.

### CROSS-REFERENCE TO RELATED APPLICATIONS

This application is a continuation of International Application No. PCT/CN2014/076277, filed on Apr. 25, 2014, which is hereby incorporated herein by reference in its entirety.

### BACKGROUND

Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking. Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression (CPI) or number of impressions, cost per click (CPC) or number of clicks, cost per action (CPA) for some specified action(s), cost per conversion or purchase, or cost based at least in part on some combination of metrics, which may include online or offline metrics, for example.

When a user issues a search query in a search engine, the search engine may provide a list of suggestions not only relevant to the query but also with enough commercial values. Once the user clicks on any of the suggestions, he/she will be re-directed to the search result page with a handful of ads based on the clicked suggestion. Thus one of the problems is how to generate a query→suggestions mapping file offline so that (1) the suggestions are relevant to the query and with good commercial value, (2) the suggestions can attract users' clicks, and (3) as many as possible queries are supported. The instant disclosure provides computer systems and methods for providing such suggestions when a query is received.

### SUMMARY

Different from conventional solutions, the disclosed system treats the above problem as a retrieval problem. Given a set of queries Q and a set of suggestion candidates SUGG, the system builds a relevance model and a click model. For any query q in Q, the system retrieves suggestions based on a relevance score R(q, sugg) and a click probability C(q, sugg), where sugg is any suggestion candidate in SUGG.

In a first aspect, the embodiments disclose a computer system for that includes one or more devices having a processor and a non-transitory storage medium accessible to the hardware processor. The system includes a database including search logs that comprises bid-terms and previous queries. The system includes a set of initial suggestion phrases extracted from the database based on frequency of appearance. The system includes a search engine in communication with the database, where the search engine is configured to generate a query search result based on a query and generate a suggestion search result based on each suggestion phrase in the set of initial suggestion phrases. The system also includes a feature generation device configured to generate a query vector and a suggestion vector based on the query search result and the suggestion search result. The system obtains a relevance score for each suggestion phrases in the set of initial suggestion phrases based on a relevance model. The system includes a subset of the initial suggestion phrases based on the relevance scores. The system also obtains a click probability score for each suggestion phrases in the subset of initial suggestion phrases based on a click model.

In a second aspect, the embodiments disclose a computer implemented method or program for commercial query suggestion. In the computer implemented method, the system generates a query search result based on a query. The system generates a suggestion search result based on each suggestion phrase from a plurality of suggestion phrases. The system extracts a query vector based on the query search result. The system extracts a suggestion vector based on the suggestion search result. The system trains a click model based on a dataset comprising click feedbacks in a database. The system obtains a relevance score between the query vector and the suggestion vector based on a relevance model. The system obtains a click probability score between the query vector and the suggestion vector based on the click model.

In a third aspect, the embodiments disclose a non-transitory storage medium configured to store a set of instructions. The set of instructions to direct a computer system to perform the following acts: generating, by one or more devices having a processor, a query search result based on a query; generating, by the one or more devices, a suggestion search result based on each suggestion phrase from a plurality of suggestion phrases; extracting, by the one or more devices, a query vector based on the query search result; extracting, by the one or more devices, a suggestion vector based on the suggestion search result; training, by the one or more devices, a click model based on a dataset comprising click feedbacks in a database; obtaining, by the one or more devices, a relevance score between the query vector and the suggestion vector based on a relevance model; and obtaining, by the one or more devices, a click probability score between the query vector and the suggestion vector based on the click model.

### BRIEF DESCRIPTION OF THE DRAWINGS

FIG. 1 is a block diagram of an example environment in which a computer system according to one embodiment of the disclosure may operate;

FIG. 2 illustrates an example computing device in the computer system for providing suggestions to a query;

FIG. 3 illustrates an example system for providing suggestions to a query;

FIG. 4 is an example block diagram illustrating embodiments of the model training;

FIG. 5A is an example block diagram illustrating embodiments of the disclosure; and

FIG. 5B is an example block diagram illustrating embodiments of the disclosure.

### DETAILED DESCRIPTION OF THE DRAWINGS

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link.

For web portals like Yahoo!, advertisements may be displayed on web pages resulting from a user defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

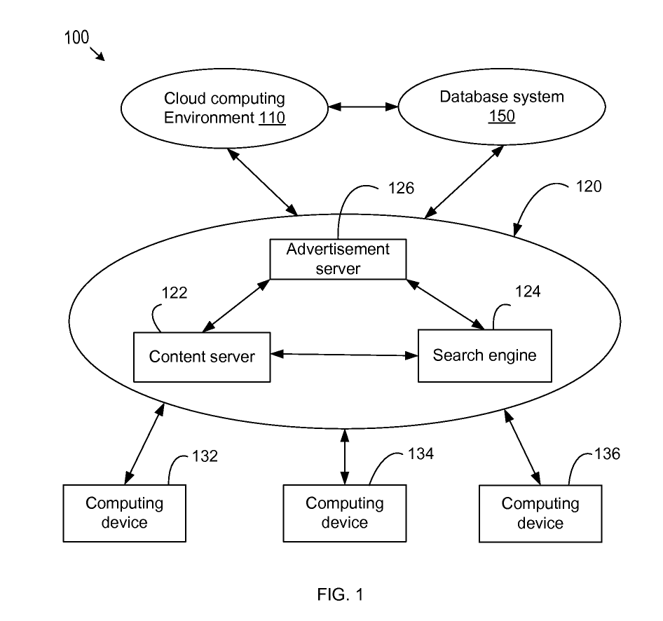

FIG. 1 is a block diagram of one embodiment of an environment 100 in which a system for providing suggestions to a query may operate. However, it should be appreciated that the systems and methods described below are not limited to use with the particular exemplary environment 100 shown in FIG. 1 but may be extended to a wide variety of implementations.

The environment 100 may include a cloud computing environment 110 and a connected server system 120 including a content server 122, a search engine 124, and an advertisement server 126. The server system 120 may include additional servers for additional computing or service purposes. For example, the server system 120 may include servers for social networks, online shopping sites, and any other online services.

The content server 122 may be a computer, a server, or any other computing device known in the art, or the content server 122 may be a computer program, instructions, and/or software code stored on a computer-readable storage medium that runs on a processor of a single server, a plurality of servers, or any other type of computing device known in the art. The content server 122 delivers content, such as a web page, using the Hypertext Transfer Protocol and/or other protocols. The content server 122 may also be a virtual machine running a program that delivers content.

The search engine 124 may be a computer system, one or more servers, or any other computing device known in the art, or the search engine 124 may be a computer program, instructions, and/or software code stored on a computer-readable storage medium that runs on a processor of a single server, a plurality of servers, or any other type of computing device known in the art. The search engine 124 is designed to help users find information located on the Internet or an intranet.

The advertisement server 126 may be a computer system, one or more servers, or any other computing device known in the art, or the advertisement server 126 may be a computer program, instructions and/or software code stored on a computer-readable storage medium that runs on a processor of a single server, a plurality of servers, or any other type of computing device known in the art. The advertisement server 126 is designed to provide digital ads to a web user based on display conditions requested by the advertiser.

The cloud computing environment 110 and the connected server system 120 have access to a database system 150. The database system 150 may include one or more databases. At least one of the databases in the database system may be a user database that stores information related to a plurality of users. The user database may be organized on a user-by-user basis such that each user has a unique record file. The record file may include all information related to a specific user from all data sources. For example, the record file may include personal information of the user, search histories of the user from the search engine 124, web browsing histories of the user from the content server 122, or any other information the user agreed to share with a service provider that is affiliated with the computer system 120.

The environment 100 may further include a plurality of computing devices 132, 134, and 136. The computing devices may be a computer, a smart phone, a personal digital aid, a digital reader, a Global Positioning System (GPS) receiver, or any other device that may be used to access the Internet.

Generally, an advertiser or any other user can use a computing device such as computing devices 132, 134, 136 to access information on the server system 120. The advertiser may want to identify a target audience for his/her product or services. In some cases, the advertiser may already have a very specific idea about the target audience. Existing solutions may require the advertisers to create a set of rules to define the desired segment of users they want to target. The rules are connected with logical connectors such as “AND/OR” to determine the qualifications of a user. Advertisers/account managers need to contend with millions of different targeting signals to identify the optimal set of signals. The signals may include all kinds of information related to each user from a plurality of sources accessible to the server system 120. The signals may relate to social network data, search history data, browsing history data, shopping activity data, demographic data, or any data users agreed to share with the server system 120. The situation becomes even tougher when determining which signals play a positive role in the segment and which are not.

Most of the time, however, the advertiser may only have general information about his market intention and it would be difficult for the advertiser to create the above rules to determine the qualifications of the desired users. For example, the advertiser may only have information about the product, the related service, some statistics about the current customers, and an image or a video related to his product or service.

In the general solutions provided by conventional advertising systems, the selected users are not ranked based on all the available information. Further, the designed rules may be connected with logical OR expressions. For example, the designed rules may include “Liked 10 social ‘Likes’ that match the advertiser's first set of specifications” OR “Liked only 1 social ‘Like’ that matches the advertiser's second specification.” In this case, one user may be selected by meeting a handful of rules related to the first set of specifications while the other users may be selected merely because of one rule related to the second specification.

The users are selected based on piecemeal information such as an incidental activity happened in the past. Each selected user meets at least one rule while each non-selected user meets no rule. Thus, the number of selected users (i.e. segment size) cannot be changed flexibly without changing the rules. Because users are not ranked based on all the available information as a whole, it is difficult for the conventional advertising systems to tune segment size to expand or reduce the target audience. The advertiser will have to change the rules (e.g. add or delete some rules on more signals), which may be tricky and risky. Sometimes some users are marginal to the advertisers. For example, advertisers would like to target users who have traveled by plane more than four times within the last month. Those who traveled three times are usually marginal to the advertisers especially when the number of selected users is less than desired. It would be difficult for the advertiser to decide which marginal users to pick using the piecemeal information.

By contrast, embodiments of the disclosed system and method solve the above problems by scoring based on extracted features and selecting the targeting audience based on the score. The disclosed system receives an input from the advertiser, where the input includes the market intention. The system then automatically analyzes the input and extracts features from the input and uses the extracted features to automatically identify the desired users. Thus, the advertiser does not have to go through all the different requirements about each keywords or signals from different data sources.

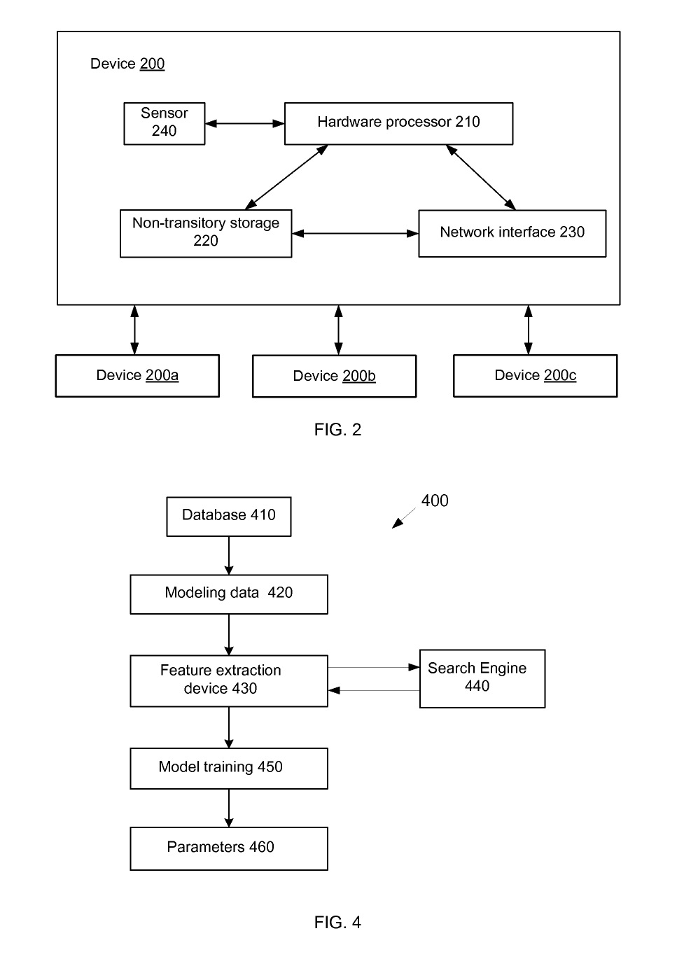

FIG. 2 illustrates an example device 200 for providing suggestions to a query. The device may 200 may be a computer, a smartphone, a server, a terminal device, or any other computing device including a hardware processor 210, a non-transitory storage medium 220, and a network interface 230. The hardware processor 210 accesses the programs and data stored in the non-transitory storage medium 220. The device 200 may further include at least one sensor 240, circuits, and other electronic components. The device may communicate with other devices 200a, 200b, and 200c via the network interface 230.

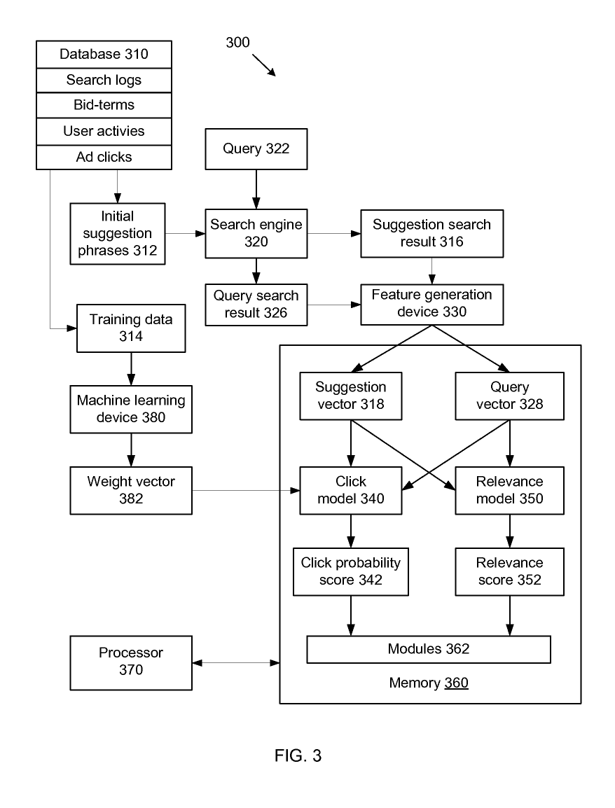

FIG. 3 illustrates an example system 300 for providing suggestions to a query. The system 300 may include one or more devices illustrated in FIG. 2. For example, the system 300 includes a search engine 320, a feature generation device 330, and a machine learning device 380, all of which may be implemented in one or more devices 200. The system also includes a processor 370 and a memory 360 accessible to the processor 370. The memory 360 may include a non-transitory storage medium and a transitory storage medium. The memory 360 may include a plurality of data modules and program modules 362. The program modules 362 may be implemented by the processor 370.

The data modules may include a suggestion vector 318 and a query vector 328 generated from the feature generation device 330. The data modules may further include necessary data for the click model 340 and the relevance model 350. The data modules may also include click probability scores 342 output from the click model 340 and relevance scores 352 output from the relevance model 350. Although the memory 360 shown in FIG. 3 only includes the above data in the box. A person having ordinary skill in the art knows that the memory may include any additional data modules and additional program modules. For example, the memory 360 may store initial suggestion phrases 312 extracted from the database 310 based on frequency of appearance. The memory 360 may store other data such as: training data 314, query 322, query search result 326, and suggestion search result 316.

The database 310 may include search logs, bid terms, user activities, and ad clicks. The database 310 may be organized on a user by user basis and includes history data from a plurality of websites accessible to the system 300. For example, the database 310 may log every activity of every user on Yahoo properties. The database 310 is configured to store Yahoo log data in which every user's activity (e.g. Page view, search, ad click, etc) is logged. When a user visits Yahoo search engine and issues a query “used car”, the search engine logs this event as well as all the context information including which web-page links shown in the search result page and which ads are shown in the search result page, which web-page link or ad the user clicks, etc.

The system may obtain training data 314 and initial suggestion phrases 312 from the database 310. The training data 314 includes the users' click feedback data. The training data may include a key (query, suggestion, position) for each month. The initial suggestion phrases 312 are extracted from the database based on frequency of appearance. For example, if the frequency of appearance of a phrase is greater than a preset threshold, the phrase is included in the set of initial suggestion phrases.

The query 322 may include a search query from a user device. The user device may be a computer, a smartphone, a server, a terminal device, or any other computing device a user may use to access the search engine 320. The query 322 may include phrases extracted from raw user data including: voice data, image data, or other data the user device can process. The user device may then send the query to the search engine 320 via a communication network.

The search engine 320 is configured to generate a query search result 326 based on the query 322. The query search result 326 may include a list of items with titles, a reference to the full version, and a short description showing where the query 322 have matched content within the page. The query search result 326 may include different types of listings: contextual, algorithmic or organic search listings, as well as sponsored listings, images, maps, definitions, videos or suggested search refinements. In one embodiment, the system 300 may parse the search result pages to collect words and phrases in the search pages. The system 300 may use top K words/phrases based on their term frequency-inverse document frequency (TF-IDF) score to characterize the query. K is an integer that may be set by the system to a reasonable value.

Similarly, the search engine 320 is configured to generate a suggestion search result 316 for each initial suggestion phrase 312. The suggestion search result 316 may include a list of items with titles, a reference to the full version, and a short description showing where the suggestion phrase 312 have matched content within the page. The search engine 320 does not differentiate between a suggestion phrase and a query 322 because the suggestion phrase may be treated as a query. Thus, the search results 316 and 326 may be processed similarly by the feature generation device 330.

The system 300 may parse all search logs in the database 310 and select n phrases as base phrases to create an n-dimensional feature space. Using the top K words/phrases, the feature generation device 330 generates a query vector 328 for the query 322. For example, each query q is represented in the feature space by a query vector q=(q₁, q₂, . . . , qₙ), in which K entries are non-zero. Here, n is an integer greater than K. Similarly, each initial suggestion phrase 312 may be represented by a suggestion vector s=(s₁, s₂, . . . , sₙ).

The relevance model 350 receives two vectors as inputs and obtains a relevance score 352 between the two vectors. For example, the relevance model 350 may calculate the relevance score 352 using cosine-similarity between the query vector 328 and the suggestion vector 318. Here, the cosine-similarity is a measure of similarity between two vectors of an inner product space that measures the cosine of the angle between them. One way to calculate the relevance score 352 between the two vectors is using the following equation:

$$Relevance ( q , s ) = {\sum }_{i = 1}^{n} {q}_{i} \times {s}_{i}$$

The relevance may be normalized by the magnitude of q and s. In that case, the relevance is normalized between 0 and 1. Generally, the relevance model 350 does not need training.

The click model 340, on the other hand, will need to be trained first using the training data 314. The machine training device 380 obtains a weight vector 382 that has the same dimension as the query vector 328 and the suggestion vector 318. The click model 340 then calculates the click probability score 342 using weighted cosine-similarity between the query vector 328 and each suggestion vector 318 with the weight vector 382. The weight vector 382 may be represented by w=(w₁, w₂, . . . , wₙ). The click probability score 342 may be calculated using the following equation.

$$Click ( q , s , w ) = {\sum }_{i = 1}^{n} {q}_{i} \times {s}_{i} \times {w}_{i} / \sqrt{( {\sum }_{i = 1}^{n} {q}_{i}^{2} \times {w}_{i} ) \times ( {\sum }_{i = 1}^{n} {s}_{i}^{2} \times {w}_{i} )}$$

The program modules 362 may then use the relevance score 352 and click probability score 342 to select the suggestions with highest commercial value. For example, the modules 362 ranks suggestion phrases from the subset of initial suggestion phrases based on the click probability scores for all initial suggestion phrases in the subset. The modules 362 may then obtain an expected revenue per click (RPC) for each suggestion phrase by multiplying the click probability score with a historical RPC. The module may select X suggestion candidates from the subset of initial suggestion phrases, where the selected X suggestion candidates have the top expected RPC, and X is an integer less than 10.

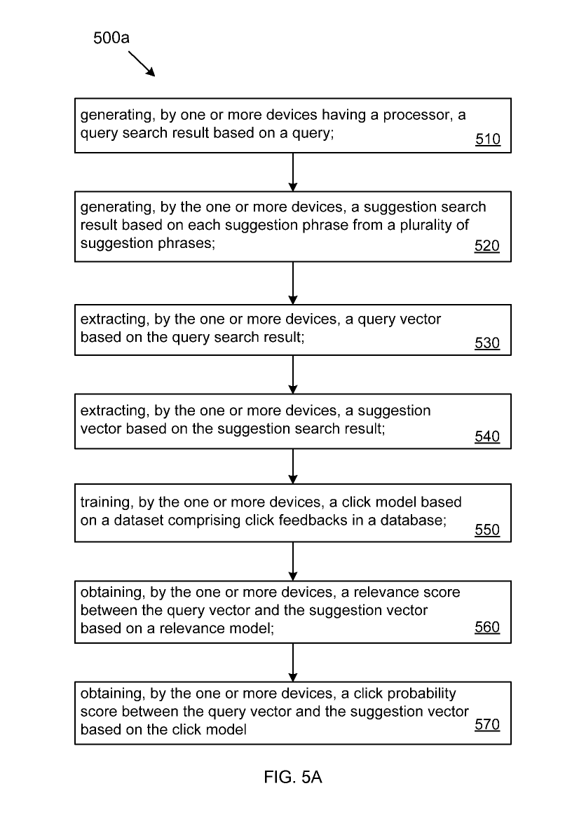

FIG. 4 is an example block diagram 400 illustrating embodiments of the model training, which is a detailed explanation of how to obtain the weight vector in FIG. 3. The model training may be implemented using any computer system. For example, the model training may be implemented in a computing device such as the machine learning device 380 illustrated in FIG. 3. Alternatively, the model training may be implemented by the processor 370 in FIG. 3.

In either case, the computer system first extracts click and view events from activities logs from the database 410. The computer system then aggregates the extracted data and organizes the data as tuples of (query, suggestion, position, #impression, #click). Then the queries and suggestions are joined with desired feature types to form modeling data 420. The modeling data 420 may include two sets: one for model training and the other for evaluation. The modeling data 420 may include history data that views and clicks for the each corresponding query or suggestion. The modeling data 420 then are provided to the feature extraction device 430, which communicates with the search engine 440. The feature extraction device 430 receives web search results from the search engine 440. The search results include query search result and suggestion search result respectively relates to the query and the suggestion. The feature extraction device 430 then generates query vectors and suggestion vectors based on the query search result and suggestion search result, respectively.

The vectors are then provided to model training 450. The model training may be implemented in any device as shown in FIG. 2. The model training method may include a machine learning method with user click feedbacks in the database 410. Many machine learning methods may be used to train the click model. For example, one approach is to leverage the Relevance Matrix Model (RMM), a general probabilistic click model. Within the RMM framework, traditional vector space model (VSM) may be treated as a simplified case of RMM and click-ability may be considered as generalized relevance as well. In the VSM and RMM, the search results are treated as vectors of identifiers, such as, for example, index terms.

Using the RMM in the training, the system had good generalization ability to model new queries and new suggestions not seen before. The learned click model may be adapted to fuse different feature spaces and results from different feature spaces. Similar to VSM, the RMM approach may be implemented within an inverted-index framework.

The model training device 430 may apply a gradient descent algorithm to learn the parameters. For example, a likelihood of the training set may be transformed into a log domain. The gradient descent algorithm may be adopted to learn parameters that maximize the likelihood.

After training, the matrix learned from training data is passed to test data set for scoring and evaluation. In the end, the best model (with best feature type and model parameters) is selected as the output to the click model. For example, the output may include a plurality of parameters 460 in the RMM. The parameters 460 may include the weight vector 382 in FIG. 3, which has the same dimension as the query vector.

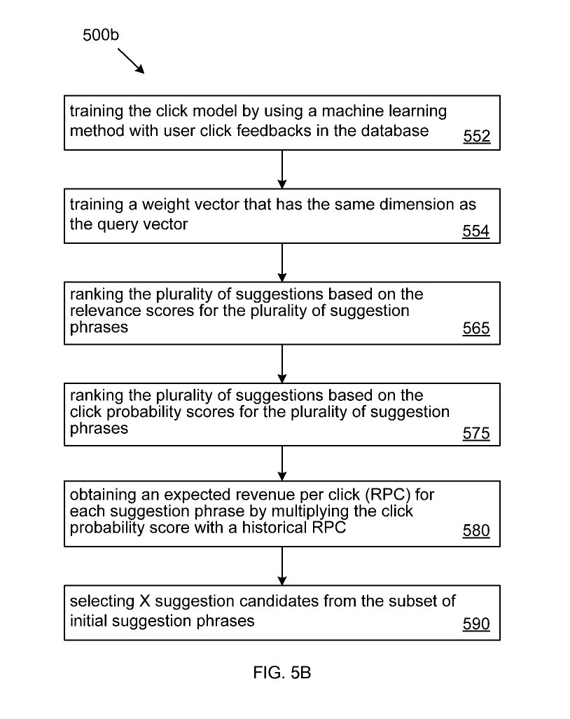

FIG. 5A is an example block diagram 500a illustrating embodiments of the disclosure. The block diagram 500a may be implemented by a computer system 300 in FIG. 3. The computer implemented method according to the example block diagram 500a includes the following acts. Other acts may be added or substituted.

In act 510, the computer system generates a query search result based on a query. The query may be extracted from a user input obtained from a user device and the query search result may be received from a search engine. Depending on the type of input from the user device, the computer system may use pattern recognition, image segmentation, natural language processing (NLP), or any other technology to extract a query from the input. The computer system may also extract features in the obtained user data for each user.

In act 520, the computer system generates a suggestion search result based on each suggestion phrase from a plurality of suggestion phrases. The plurality of suggestion phrases may be selected from a database connected to the computer system based on frequency of appearance in the database during a certain period of time.

In act 530, the computer system extracts a query vector based on the query search result. The query vector may only include K non-zero elements to reduce noise. Here, K may be a preset number in the computer system.

In act 540, the computer system extracts a suggestion vector based on the suggestion search result. The suggestion vector has the same dimension as the query vector.

In act 550, the computer system trains a click model based on a dataset including user click feedbacks in a database. Many machine learning methods may be used to train the click model. For example, the computer system may use the RMM model in training the click model. Other machines learning models may also be used.

In act 560, the computer system obtains a relevance score between the query vector and the suggestion vector based on a relevance model. Generally, the relevance model does not need training. The relevance score may be normalized if necessary.

In act 570, the computer system obtains a click probability score between the query vector and the suggestion vector based on the click model.

FIG. 5B is an example block diagram 500b illustrating embodiments of the disclosure. The acts in block diagram 500b may be combined with the acts in the block diagram 500a shown in FIG. 5A. Similarly, the acts in block diagram 500b may be implemented by a computer system 300 disclosed in FIG. 3. The computer implemented method according to the example block diagram 500b includes the following acts. Other acts may be added or substituted.

In act 552, the computer system trains the click model by using a machine learning method with user click feedbacks in the database. This act may be included in act 550 in FIG. 5A.

In act 554, the computer system trains a weight vector that has the same dimension as the query vector. This act may be included in act 550 in FIG. 5A.

In act 565, the computer system ranks the plurality of suggestions based on the relevance scores for the plurality of suggestion phrases. This act may follow the act 560 in FIG. 5A.

In act 575, the computer system ranks the plurality of suggestions based on the click probability scores for the plurality of suggestion phrases. This act may follow the act 570 in FIG. 5A.

In act 580, the computer system obtains an expected revenue per click (RPC) for each suggestion phrase by multiplying the click probability score with a historical RPC. This act may follow the act 570 in FIG. 5A.

In act 590, the computer system selects X suggestion candidates from the subset of initial suggestion phrases.

The disclosed computer implemented method may be stored in computer-readable storage medium. The computer-readable storage medium is accessible to at least one hardware processor. The processor is configured to implement the stored instructions to select a target audience based on extracted features from the user data and the advertiser input.

From the foregoing, it can be seen that the present embodiments provide a computer system that includes two major steps. First, the computer system exploits the wisdom of web search engine to understand the semantics of each query by extracting features from web search results. The features are typically words and phrases. Second, the computer system learns from user feedbacks and builds click prediction models based on the features extracted in the first step.

The disclosed system combines the wisdom of both web search engine and web users and has the following advantages. The computer system provides suggestions that are relevant with queries because the search engine provides robust semantic information. Suggestion candidates for a query are no longer only from the matched bid-terms, but from the whole set of queries. It dramatically increases the coverage and depth of commercial query suggestion. The computer system includes the click probability explicitly by learning from user click feedbacks and thus significantly boosts the click through rate (CTR) of commercial query suggestions. Finally, the calculation and ranking can be done in an inverted-index framework so that it achieves 2X speed up than existing solutions.

It is therefore intended that the foregoing detailed description be regarded as illustrative rather than limiting, and that it be understood that it is the following claims, including all equivalents, that are intended to define the spirit and scope of this invention.

What is claimed is:

1. A system comprising a processor and a non-transitory storage medium accessible to the processor, the system comprising:
a database comprising search logs that comprises bid-terms and previous queries;
a set of initial suggestion phrases extracted from the database based on frequency of appearance;
a search engine in communication with the database, the search engine configured to generate a query search result based on a query and generate a suggestion search result based on each suggestion phrase in the set of initial suggestion phrases;
a feature generation device configured to generate a query vector and a suggestion vector based on the query search result and the suggestion search result;
a relevance score for each suggestion phrases in the set of initial suggestion phrases based on a relevance model;
a subset of the initial suggestion phrases based on the relevance scores; and
a click probability score for each suggestion phrases in the subset of initial suggestion phrases based on a click model.

2. The system of claim 1, wherein the subset of the initial suggestion phrases comprises M suggestion phrases having top M relevance scores, M is an integer greater than 20.

3. The system of claim 1, further comprising:
a module that ranks suggestion phrases from the subset of initial suggestion phrases based on the click probability scores.

4. The system of claim 1, further comprising:
a module that obtains an expected revenue per click (RPC) for each suggestion phrase by multiplying the click probability score with a historical RPC.

5. The system of claim 1, further comprising:
a module that selects X suggestion candidates from the subset of initial suggestion phrases, the selected X suggestion candidates having the top expected RPC, and X is an integer less than 10.

6. The system of claim 1, wherein the relevance model calculates the relevance score using cosine-similarity between the query vector and each suggestion vector.

7. The system of claim 1, further comprising:
a module that trains the click model by using a machine learning method with user click feedbacks in the database comprising search logs, the machine learning method trains a weight vector that has the same dimension as the query vector.

8. The system of claim 7, wherein the click model calculates the click probability score using weighted cosine-similarity between the query vector and each suggestion vector with the weight vector.

9. A method, comprising:
generating, by one or more devices having a processor, a query search result based on a query;
generating, by the one or more devices, a suggestion search result based on each suggestion phrase from a plurality of suggestion phrases;
extracting, by the one or more devices, a query vector based on the query search result;
extracting, by the one or more devices, a suggestion vector based on the suggestion search result;
training, by the one or more devices, a click model based on a dataset comprising click feedbacks in a database;
obtaining, by the one or more devices, a relevance score between the query vector and the suggestion vector based on a relevance model; and
obtaining, by the one or more devices, a click probability score between the query vector and the suggestion vector based on the click model.

10. The method of claim 9, wherein the subset of the initial suggestion phrases comprises M suggestion phrases having top M relevance scores, M is an integer greater than 20.

11. The method of claim 9, further comprising:
ranking the plurality of suggestions based on the relevance scores for the plurality of suggestion phrases.

12. The method of claim 11, further comprising:
ranking the plurality of suggestions based on the click probability scores for the plurality of suggestion phrases.

13. The method of claim 9, further comprising:
obtaining an expected revenue per click (RPC) for each suggestion phrase by multiplying the click probability score with a historical RPC.

14. The method of claim 13, further comprising:
selecting X suggestion candidates from the subset of initial suggestion phrases, the selected X suggestion candidates having the top expected RPC, and X is an integer less than 10.

15. The method of claim 9, further comprising: training the click model by using a machine learning method with user click feedbacks in the database comprising search logs, the machine learning method trains a weight vector that has the same dimension as the query vector.

16. The method of claim 15, wherein:
obtaining the relevance score comprises calculating the relevance score using cosine-similarity between the query vector and each suggestion vector; and
obtaining the click probability score comprises calculating the click probability score using weighted cosine-similarity between the query vector and each suggestion vector with the weight vector.

17. A non-transitory storage medium configured to store a set of instructions, the set of instructions to direct a computer system to perform acts of:
generating, by one or more devices having a processor, a query search result based on a query;
generating, by the one or more devices, a suggestion search result based on each suggestion phrase from a plurality of suggestion phrases;
extracting, by the one or more devices, a query vector based on the query search result;
extracting, by the one or more devices, a suggestion vector based on the suggestion search result;
training, by the one or more devices, a click model based on a dataset comprising click feedbacks in a database;
obtaining, by the one or more devices, a relevance score between the query vector and the suggestion vector based on a relevance model; and
obtaining, by the one or more devices, a click probability score between the query vector and the suggestion vector based on the click model.

18. The non-transitory storage medium of claim 17, wherein the set of instructions to direct the computer system to perform acts of:
ranking the plurality of suggestions based on the relevance scores for the plurality of suggestion phrases; and
ranking the plurality of suggestions based on the click probability scores for the plurality of suggestion phrases.

19. The non-transitory storage medium of claim 17, wherein the set of instructions to direct the computer system to perform acts of:
obtaining an expected revenue per click (RPC) for each suggestion phrase by multiplying the click probability score with a historical RPC; and
selecting X suggestion candidates from the subset of initial suggestion phrases, the selected X suggestion candidates having the top expected RPC, and X is an integer less than 10.

20. The non-transitory storage medium of claim 17 wherein the set of instructions to direct the computer system to perform acts of:
training the click model by using a machine learning method with user click feedbacks in the database comprising search logs, the machine learning method trains a weight vector that has the same dimension as the query vector;
calculating the click probability score using weighted cosine-similarity between the query vector and each suggestion vector with the weight vector; and
calculating the relevance score using cosine-similarity between the query vector and each suggestion vector,
wherein the subset of the initial suggestion phrases comprises M suggestion phrases having top M relevance scores, M is an integer greater than 20.
